(19) United States
(12) Patent Application Publication
(10) Pub. No.: US 2009/0052328 A1
(43) Pub. Date: Feb. 26, 2009

(54) METHOD OF DETERMINING CONFIGURATION ERRORS IN NETWORKS

(76) Inventors: Markus Rentschler, Dettingen (DE); Oliver Kleineberg, Wendlingen (DE)

Correspondence Address: K.F. ROSS P.C., 5683 RIVERDALE AVENUE, SUITE 203 BOX 900, BRONX, NY, 10471-0900, US

(21) Appl. No.: 12/195,634

(22) Filed: Aug. 21, 2008

(30) Foreign Application Priority Data
Aug. 21, 2007 (DE) 102007039484.7

(51) Int. Cl. H04L 12/24; H04L 12/26

(52) U.S. Cl. 370/241; 370/216

(57) ABSTRACT

Configuration errors on interconnected network infrastructure devices are detected in a network where each network infrastructure device supplies information about its own configuration at its own network interface and sends this information to a neighboring network infrastructure device via a discovery protocol. Furthermore each network infrastructure device removes from the network the configuration data received at its interfaces in order to prevent this data from being passed on to other network infrastructure devices, and the received configuration data of the neighboring network infrastructure devices is stored as a data structure on one of the network infrastructure devices in a storage unit. The information about the neighboring network infrastructure devices is made available by the storage device of the first network infrastructure device and used to detect error configurations between the respective devices by comparison with the data deposited in the storage unit.

### FIELD OF THE INVENTION

The present invention relates to a method of determining a configuration error in a network. More particularly this invention concerns a network that supplies information about its own configuration at its own network interface and sends this information to a neighboring network infrastructure device.

### BACKGROUND OF THE INVENTION

The transfer of information between infrastructure devices by means of discovery protocols is known in the prior art.

In the following, devices that are necessary for operating the network, for example, in the form of a (central) mediating unit, are designated as “devices,” “infrastructure devices” or “network infrastructure devices.” Examples of such devices are ethernet switches and routers.

Devices that are not necessary as active components for network operation, but rather use the network that has been made available for productive operation, are designated in the following as “clients.” Examples of clients might include notebook computers, personal computers or control units of machines with ethernet interfaces.

Many modern infrastructure devices support at least one form of a discovery protocol, such as the LLDP (Link Layer Discovery Protocol) standardized by the IEEE (Institute of Electrical and Electronics Engineers) or the proprietary CDP (Cisco Discovery Protocol), to send information about their own configurations to their own network interfaces.

The purpose of this information packet is to enable a device to notify directly connected neighboring devices of its own presence and in some cases to configure its own interfaces.

The configuration data, so-called information PDU's (Protocol Data Units), are sent more or less without connections, that is, each switch merely makes its own information available at its interfaces, regardless of whether or not a receiving device is connected.

If all the devices in a network infrastructure support a given discovery protocol, then every device sends its information to all interfaces, and receives and analyzes the information of its direct neighbor at the respective interface through which this neighbor is connected (see FIG. 5).

Furthermore, every device removes the information PDU's received at its interfaces from the network in order to prevent their being passed on to other infrastructure devices, since it is only ever the direct neighbor of a device that should receive the respective PDU'S.

The data of the neighboring device, received via the information PDU'S, are usually stored on each individual device in a data structure, the so-called MIB (Management Information Base).

These MIB's can be accessed via a management interface, such as the SNMP (Simple Network Management Protocol), and the neighbor's updated information can be read out.

In addition to the information received from its neighbors, every device usually also stores the configuration of its own interfaces in the MIB. Depending on the configuration of the devices, there can be deviations as a result of different settings in the implemented configuration.

### OBJECTS OF THE INVENTION

It is therefore an object of the present invention to provide an improved method of determining configuration errors in networks.

Another object is the provision of such an improved method by which the neighboring information available on network infrastructure devices via discovery protocols (such as LLDP) can be used to detect configuration errors between the local device and the remote device.

### SUMMARY OF THE INVENTION

Thus according to the invention the information about the neighboring network infrastructure devices, made available by the storage unit of the first infrastructure device, is used to detect error configurations between the respective devices by means of comparison of the data deposited in the storage unit.

Error configurations are detected as follows:

The information about the neighboring devices and the local devices, made available by the storage unit (MIB), can be used to detect error configurations between the respective devices.

To do this, the information in the existing MIB pertaining to the interface in the queried device and the interface in the neighboring device is ascertained for every device detected via the discovery protocol.

Thereafter, the information is reciprocally analyzed, which results in one out of many possible constellations of the interface configuration.

This constellation is subsequently evaluated by an analysis logic. Depending on the existing configuration, the analysis finds error-free or faulty configurations between the two devices.

This information can now be released to the end user via an interface in order to inform the end user of the problem in the device configuration.

A concrete example would be two network switches that are connected with one another via a twisted pair copper cable. On the local device, that is the device on which the MIB is accessed for example via SNMP, the network interface, to which the neighboring device is connected, is automatically configured to 100 Mbit Full Duplex Automatic.

On the neighboring device, the network interface to which the local device is connected is configured to 100 Mbit Full Duplex Manual.

This constellation can possibly lead to operating problems. The analysis logic compares the information of the local interface and of the neighboring interface and discovers this configuration problem. Afterwards the problem is reported to the user in the administration surface of the switch.

Furthermore, it is also possible to use local error detection for global error detection. The error detection described thus far offers individually for each infrastructure device an error detection in the context of the respective local device.

Since this error detection can be carried out individually on each device, for every device local error detection data are available in the entirety of the infrastructure.

If these respective local data are made available to a higher level, for example to a software component for network management, then network-overlapping errors can be detected via the local data, for example VLAN's (Virtual Local Area Networks) configured wrongly via different switches in the context of the entire network.

The deployment of error detection is therefore not necessarily limited to a device-related context, for example the representation of an individual infrastructure device in the management interface, but rather can also occur within a higher management level such as a software component for network management.

### BRIEF DESCRIPTION OF THE DRAWING

The above and other objects, features, and advantages will become more readily apparent from the following description, reference being made to the accompanying drawing in which:

FIG. 1 is a schematic diagram of a network according to the invention;

FIG. 2 is another view of the FIG. 1 network;

FIG. 3 is another schematic view illustrating the system of this invention;

FIG. 4 is another diagram illustrating functioning of the inventive system; and

FIG. 5 illustrates the prior art.

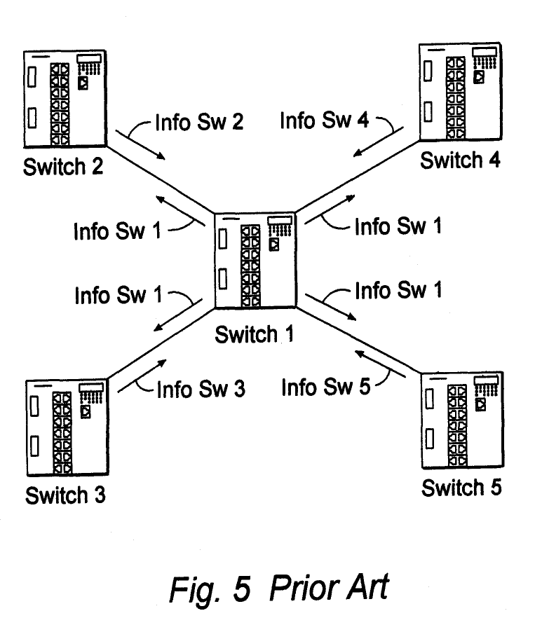

### SPECIFIC DESCRIPTION

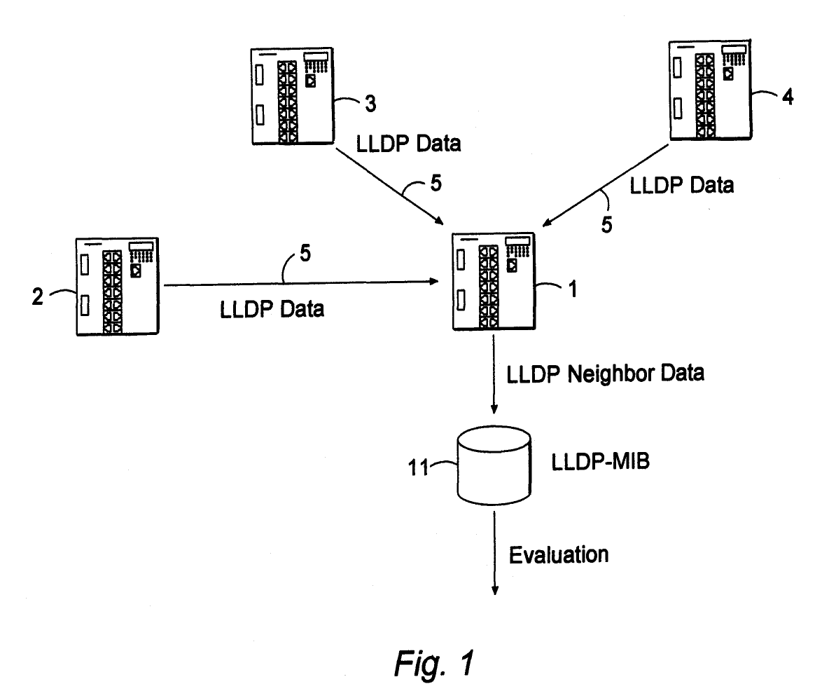

As seen in FIG. 1 a network infrastructure has multiple network infrastructure devices 1 to 4 that are connected to one another via respective data lines 5. One of these network infrastructure devices 1 collects via data lines 5 the configuration data from the other connected network infrastructure devices 2 to 4, to which end these data streams are transmitted by means of a discovery protocol, for example LLDP, to the network infrastructure device 1 and collected there. In the network infrastructure device 1 there is a memory or storage unit 11, for example an LLDP-MIB, in which the transmitted configuration data of network infrastructure devices 2 to 4 and also of the collecting network infrastructure device 1 are stored. The information about neighboring network infrastructure devices 2 to 4, made available by the storage unit 11 of the first infrastructure device 1, and the latter's own information, are used to detect error configurations between the respective devices by means of comparison of the data stored in the memory 11.

This is done, for example, by the information existing in storage unit 11 being ascertained for the interface on the queried network infrastructure device 1 and for the interface on the neighboring network infrastructure device 2 or 3 or 4 via the discovery protocol, such as LLDP or a different one, and by the information then being analyzed reciprocally (to which end the respective network infrastructure device 1 has the necessary hardware and software), resulting in one out of many possible constellations of the interface configuration being found.

That means that the individual configurations of the network infrastructure devices 1 to 4 can be entered into a table and compared, resulting in an error-free state if the network infrastructure devices connected with one another via a data line 5 (for example 1 with 2 or 1 with 3 or 1 with 4 in the network infrastructure of FIG. 1) conform to one another, or in the presence of an error if the mentioned configurations of the reciprocally connected network infrastructure devices deviate from one another.

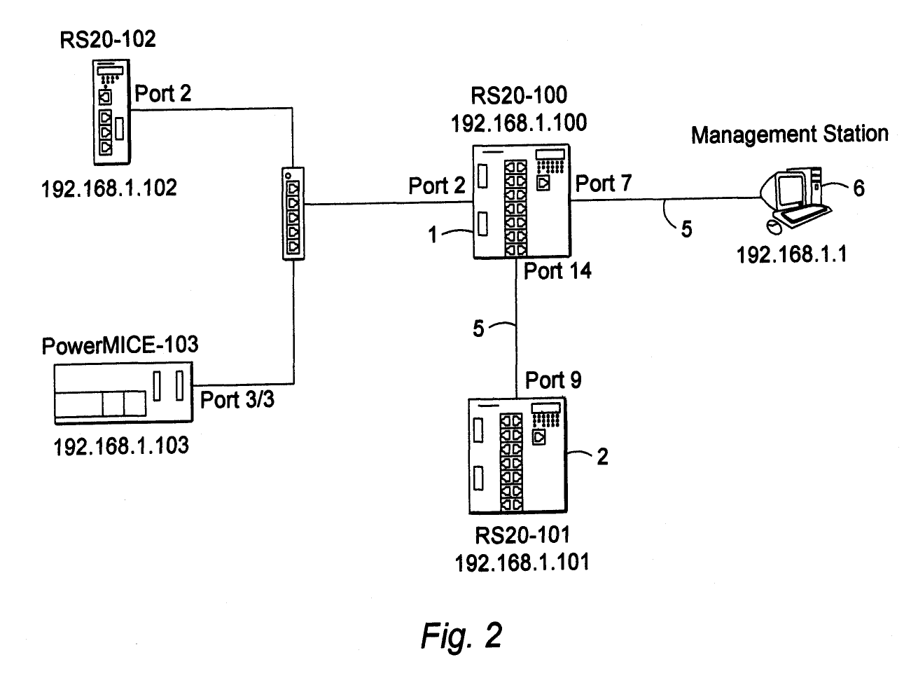

FIG. 2 shows a portion of the network infrastructure present in FIG. 1. That means that the network infrastructure device 1 has storage unit 11 and that the network infrastructure device 2 is connected to it. In addition, there are other clients, for example an RS 20-102 or a Power MICE 103. The network infrastructure device 1 makes the local configuration data (its own and that of network infrastructure device 2 or of other network infrastructure devices) available to a higher network management unit 6, in order thereby to detect and correct network-overlapping errors using the local configuration data of network infrastructure devices 1, 2 and others.

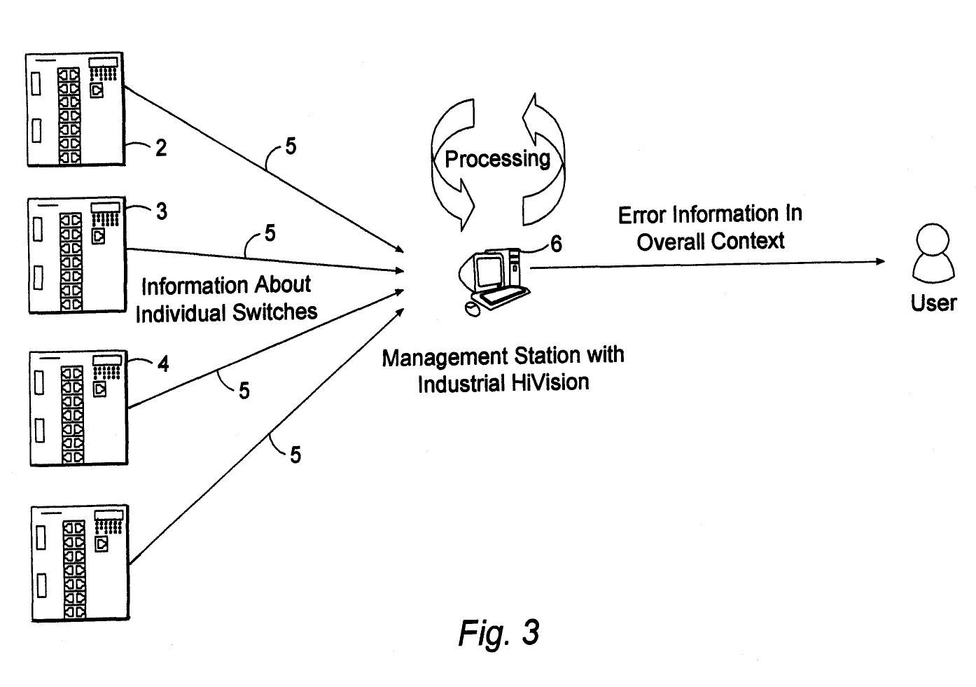

This overlapping error detection is shown in FIG. 3, where multiple network infrastructure devices 1 to 4 (potentially even more) are connected to network management unit 6 via respective data lines. Every network infrastructure device 1 to 4, as shown in FIG. 3, acts as the network infrastructure device that assumes the functionality of network infrastructure device 1 of FIG. 1. In this way it is possible to detect errors within a complex network topology, process them in network management unit 6 and make error information in the entire context of the network topology available to a user. That makes it possible for an error within the configuration to be detected by connected devices in a network infrastructure and made available to a user. This user can by means of an appropriate intervention change or adapt the configuration data of the network infrastructure devices assigned to one another, so that there is no longer any reciprocal deviation and thus the problem is corrected.

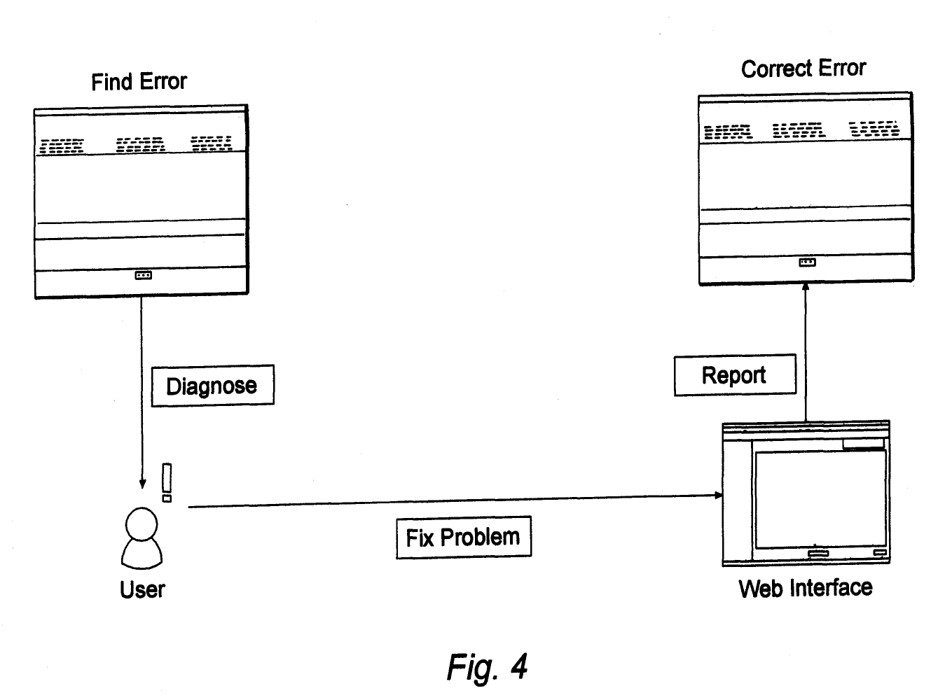

This problem correction can be displayed then in the network management unit, so that the user can recognize that the error has been corrected. This positive feedback between error detection, display to the user, problem correction, report-back and display of the error correction is shown in FIG. 4.

It is conceivable that error correction by a user, particularly a system administrator, following error detection can be carried out manually, or alternatively that error correction following error detection can occur automatically. Error correction by a user following error detection has the advantage that an intervention in the network infrastructure is done deliberately for the purpose of error correction, and the user also obtains knowledge of errors and their correction. The important thing is that the user is able to recognize whether the ascertained error is an actual error, and if so, by what means and method he wishes to correct it. If that is not desired, the error correction will occur automatically according to programmed processes, since this can be done faster in the case of standard errors, for example, and the user does not need to intervene. He or she can have the process displayed, however, so as to be simply notified about an error and its automatic correction.

We claim:

1. A method for detecting error configurations on interconnected network infrastructure devices, the method comprising the steps of:
each network infrastructure device supplying information about its own configuration at its own network interface and sending this information to a neighboring network infrastructure device via a discovery protocol;
each network infrastructure device removing from the network the configuration data received at its interfaces in order to prevent this data from being passed on to other network infrastructure devices;
storing the received configuration data of the neighboring network infrastructure devices as a data structure on one of the network infrastructure devices in a storage unit; and
making available the information about the neighboring network infrastructure devices by the storage device of the first network infrastructure device and using it to detect error configurations between the respective devices by comparison with the data deposited in the storage unit.

2. The method defined in claim 1 wherein the information existing in the storage unit is ascertained for the interface on the queried network infrastructure device and for the interface on the neighboring network infrastructure device via the discovery protocol, and the information is subsequently analyzed reciprocally, resulting in one out of many possible constellations of the interface configuration being found.

3. The method defined in claim 2 wherein these found constellations are evaluated by an analysis logic such that, depending on the existing configuration, the evaluation finds error-free or faulty configurations between the two devices, and this information is released to the end user via an interface in order to inform the end user about the problem in the device configuration.

4. The method defined in claim 2 wherein the local configuration data of at least one network infrastructure device are made available to a higher network management unit in order thereby to detect network-overlapping errors via the local configuration data.

5. The method defined in claim 2 wherein the error correction following error detection is carried out manually by a user, in particular a system administrator.

6. The method defined in claim 2 wherein the error correction following error detection is done automatically.
